(19) United States
(12) Patent Application Publication
(10) Pub. No.: US 2016/0173633 A1
(43) Pub. Date: Jun. 16, 2016

(54) MEDIA QUEUING

(71) Applicant: Yahoo!, Inc., Sunnyvale, CA (US)

(72) Inventors: Eric Bax, Altadena, CA (US); John Peng, Burbank, CA (US); Wayne Greenwood, La Honda, CA (US); Lane Hiers, San Jose, CA (US); Frank Filippini, Redwood City, CA (US); Lisa Giaffo, Pasadena, CA (US); Scott Ard, Pleasanton, CA (US)

(21) Appl. No.: 14/569,848

(22) Filed: Dec. 15, 2014

(51) Int. Cl. H04L 29/08

(52) U.S. Cl. CPC H04L 67/2838; H04L 67/2842; H04L 67/02

(57) ABSTRACT

One or more methods and/or techniques for media queuing are provided herein. A user, of a client device, may search for a media item (e.g., a movie, video, and/or TV show). The media item may be provided by one or more content providers (e.g., businesses that provide media items in one or more formats, such as for rental, purchase, download, pickup, etc.). Responsive to the media item being of interest to the user, one or more media queuing options may be presented to the user. The media queuing options may correspond to one or more formats and/or one or more content providers (e.g., rental from a first content provider; purchase from a second content provider; etc). Responsive to the user invoking a media queuing option, the media item may be queued for consumption by the user.

### BACKGROUND

When a user on a client device is searching for a media item (e.g., a movie, a television show, a digital book, a videogame, an app, digital music, and/or other media, such as user created videos) the user may be directed to one or more content providers (e.g., a streaming provider that streams media, a media provider such as a cable or satellite provider, a media merchant, or some other provider that allows the user to access media). The content provider may or may not have the media item readily available, and if the media item is available, then the media item may not be available in a format (e.g., streaming media, broadcast media, stored media, downloadable media, tangible media available for physical pickup, etc.) that the user desires.

After identifying a content provider, the user may spend extensive amounts of time and/or computing resources searching for the media item in the format that the user desires. In an example, the user may find the media item on a first content provider that can provide the media item at a later point in time (e.g., the content provider may provide the media item at a set airing time), but the user may desire to watch the media item immediately. In another example, the user may find the media item on the second content provider in the format that the user desires, but the user may not have an account with the second content provider. The user may have an account with a third content provider, but the user may be unaware that the third content provider offers the media item in the format that the user desires. If the user does not find the media item in the format that the user desires, and/or from a content provider for which the user has an account, the user may forgo watching the media item.

### SUMMARY

In accordance with the present disclosure, a media item reference, within content provided to a user by a first content provider, may be identified. The content may comprise a website, a search engine results page, a social network post, a message, and/or an application. The media item reference may be identified based on an evaluation of a user profile (e.g., the user may express an interest in a Scary Halloween Movie media item; user identifying information, such as age, gender, geographic location, and/or other user trait information, may be indicative of an interest in the Scary Halloween Movie media item; etc.) and/or a user history (e.g., the user may have searched for scary movies; the user may have joined and/or participated in a Halloween Movie Enthusiasts forum; the user may have watched various scary movies; the user may have messaged other users about an actor in the Scary Halloween Movie media item; the user may have posted a social network post “I really love streaming scary movies”; etc.) to determine that the user has an interest in the media item greater than an interest threshold.

A second content provider, that provides the media item referenced by the media item reference, may be identified. The second content provider may comprise a streaming provider that streams media, a media provider such as a cable or satellite provider, a media merchant that sells media, or some other provider that provides media items. In an example where the user has an account with the second content provider, the user may establish a link to the account. For example, a device identifier of the client device may be linked with the second content provider to create the link. The link may be utilized to identify the second content provider as providing one or more media items for consumption by the user. Any number of content providers, such as a third content provider, may be identified as providing the media item.

A media queuing option may be provided for the media item. The media queuing option may comprise a media item purchase option (e.g., an option to purchase the media item for digital access, mail order, store pickup, or download), a media item viewing option (e.g., an option to stream the media item), a media item reservation option (e.g., an option to reserve the media item for future viewing), a media item pickup option (e.g., an option to reserve a tangible copy of the media item for pick up at a physical location), a media item bookmark option (e.g., an option to save a web address and/or website linking to the media item for future viewing), and/or a media item record option (e.g., an option to record the media item). Any number of media queuing options, for any number of content providers that provide the media item, may be provided to the user. For example, a second media queuing option may be provided for the media item. The second media queuing option may correspond to an option to purchase the media item from the third media provider. The media queuing option may be displayed on a search engine results page. The media queuing option may be displayed in a first location of the search engine results page based upon a first media queue bid submitted by the second content provider. The second media queuing option may be displayed in a second location of the search engine results page based upon a second media queue bid submitted by the third content provider (e.g., the second media queue bid may have been lower than the first media queue bid), the first location having a higher visibility prominence metric than the second location.

Responsive to receiving an invocation of the media queuing option, the media item may be queued for consumption through the second content provider and/or a notification of the successful queuing may be provided to the user. In an example, the invocation may correspond to a single user interaction with the media queuing option. The invocation may comprise redirecting the user to a user interface, populated with contextually relevant information associated with the media item, provided by the second content provider (e.g., deep launching an application into a purchase interface for the media item). The invocation may comprise submitting user account credentials, of the user, to the second content provider, and instructing the second content provider to queue the media item for consumption by the user. Responsive to receiving a second invocation of the second media queuing option, the media item may be queued for consumption through the third content provider.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of media queuing.

FIG. 5A is a component block diagram illustrating an example system for media queuing.

FIG. 5B is a component block diagram illustrating an example system for media queuing, where a media queuing option is selected.

FIG. 6A is a component block diagram illustrating an example system for media queuing.

FIG. 6B is a component block diagram illustrating an example system for media queuing, where a media record option is selected.

FIG. 7 is a component block diagram illustrating an example system for media queuing, where media queuing options are ranked.

FIG. 8 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

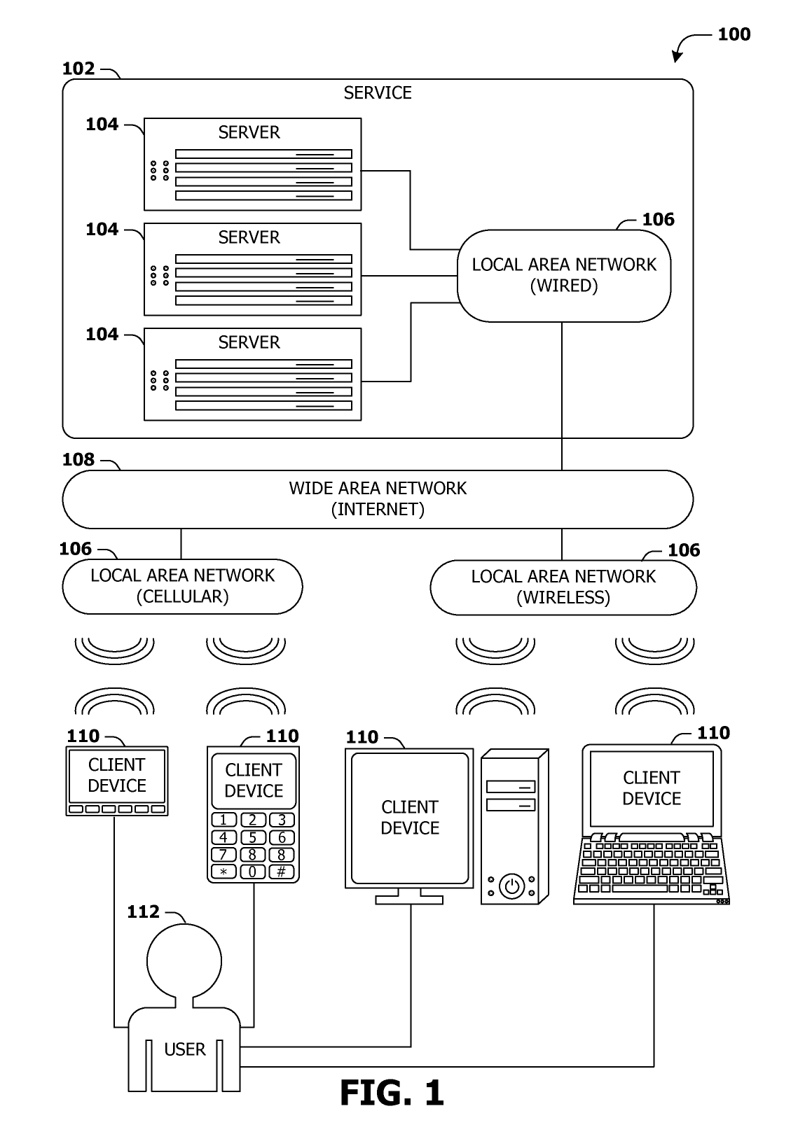

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

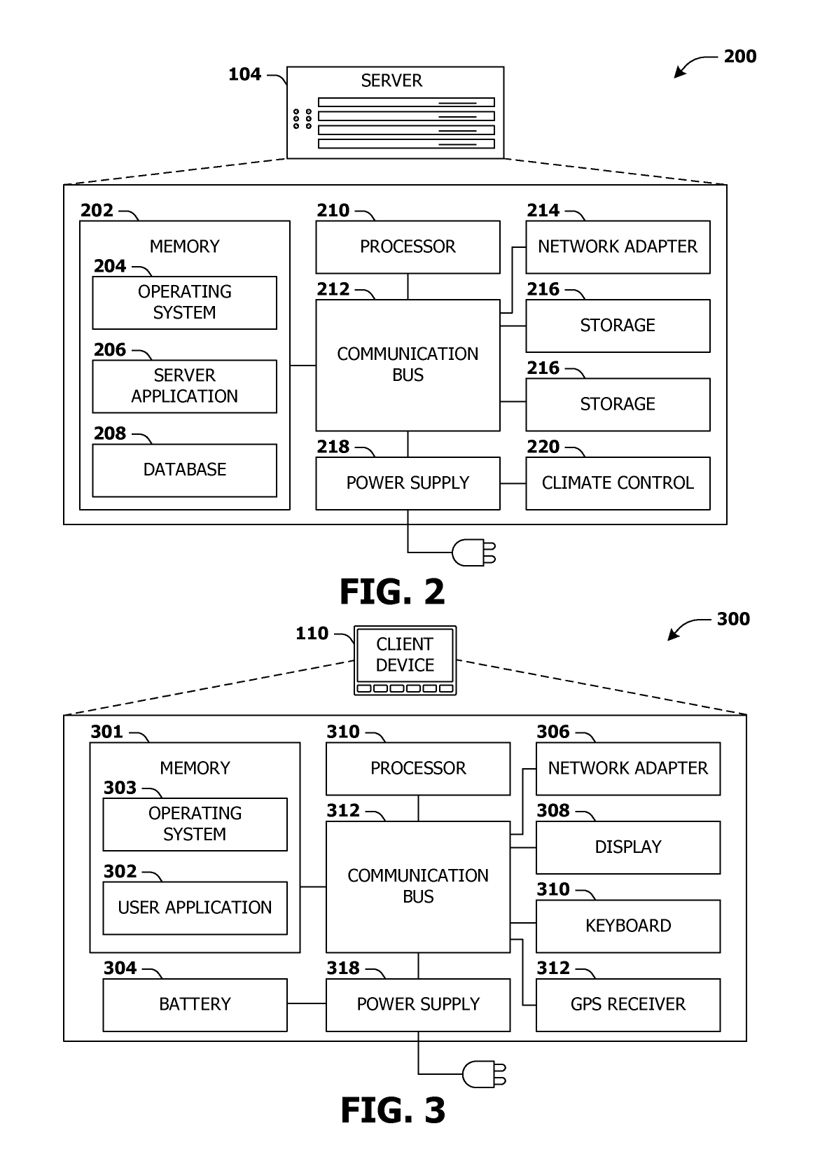

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one”device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques for media queuing are provided herein. A user may search for a media item (e.g., a movie, a television show, a digital book, digital music, a videogame, an app, and/or other media such as user created videos) and may be directed to one or more content providers (e.g., a streaming provider that streams media, a media provider, a media merchant that sells media items, etc.). The user may spend extensive amounts of time and/or computing resources searching for the media item in the format that the user desires and/or from a source with which the user has an account. In an example, the user may find the media item on a first content provider that provides the media item at a specific broadcast time during which the user may not be available to consume the media item. In another example, the user may find the media item in a format that may be watched immediately, but the user may wish to record the media item for later viewing. Unfortunately, the user may find the media item in an undesirable format and/or from content providers with which the user does not have an account, and thus the user may forgo watching the media item.

Accordingly, as provided herein, media items, available from various content providers in various formats, may be identified and exposed to the user for consumption, which may mitigate computing resources, such as battery power consumption, processing resources, and/or bandwidth, otherwise wasted by the user in performing multiple searches to identify a content provider that has the media item in the format the user desires.

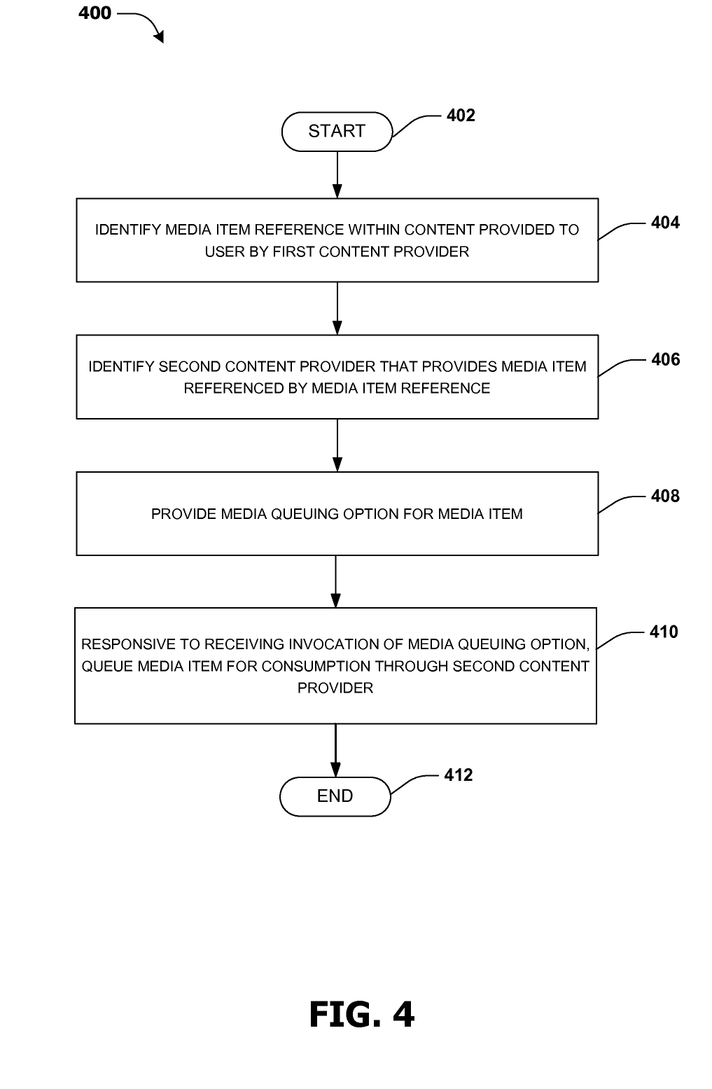

An embodiment of media queuing is illustrated by an example method 400 of FIG. 4. At 402, the method 400 starts. At 404, a media item reference may be indentified within content provided to a user by a first content provider. The first content provider may comprise a search engine, a webmail service, a social network, etc. The content may comprise a website, a search engine results page, a social network post, a message, and/or an application. The media item reference may be identified based on an evaluation of a user profile and/or a user history (e.g., a user viewing history) to determine that the user has an interest in a media item, referenced in the media item reference, greater than an interest threshold.

The user profile may comprise information about the user's preference regarding media items, such as a preferred type of media item (e.g., horror, action, comedy, etc.), a favorite actor, a favorite actress, a favorite director, etc. The user profile may comprise demographic information (e.g., age, gender, etc. of the user) and/or geographic information (e.g., state, country, etc. in which the user resides). The user history may comprise a number of instances that the user viewed a certain type of media item (e.g., a genre, such as horror, action, fantasy, comedy, etc.), a number of times the user viewed media items with certain actors, actresses, and/or directors, association information (e.g., information about media item preferences and/or a number of times the user's social media connections, email recipients, etc. mentioned the media item, actors, actresses, directors, etc.), and/or behavioral information (e.g., information about the user's habits and/or custom with regard to the media item or other similar media items).

The interest threshold may comprise a value (e.g., an interest threshold value may be set to 10 points such that a user interest score above 10 points may indicate that the user has an interest in the media item) derived from the user history and/or the user profile. In an example, if the media item stars Johnny Danger (e.g., a famous actor) and the user history indicates the user has watched several (e.g., three or more) Johnny Danger media items within a timeframe (e.g., 1 year), then a relatively higher user interest score may be assigned to the media item (e.g., 12 points or any other score over the interest threshold, thus indicating that the user may be interested in the media item). Various scoring techniques may be used, such as increasing a user interest score based upon a number of positive social network comments by the user about the media item or decreasing the user interest score based upon negative social network comments.

In an example, if the media item is in the horror genre and the user history indicates the user has watched merely a few (e.g., two or fewer) media items in the horror genre within the last year, then a relatively lower user interest score may be assigned to the media item (e.g., a score of 8 points or any other score below the interest threshold). In another example, if the media item is in the horror genre and the user profile indicates that the user does not have a preference for media items in the horror genre, (e.g., the user states a preference for media items in the action genre, comedy genre, etc., but does not indicate the preference for the horror genre, or the user states “I hate being scared”), then a relatively lower user interest score may be assigned to the media (e.g., each negative indicator may be used to reduce the score by a particular amount).

Terms and/or phrases near the media item reference (e.g., adjacent words, a sentence comprising the media item reference, etc.) may be evaluated to determine the user interest score. In an example, positive terms (e.g., watch, view, see, and/or the like) near the media item reference may indicate that the user has an interest in the media item over the interest threshold because those terms are indicative of an interest in watching the media item (e.g., the user may create a social network post “I cannot wait to watch the new Racing Movie”). Positive terms may be used to increase the user interest score and negative terms (e.g., “I don't like,” “I hate,” “why do people watch,” and/or the like) may be used to decrease the user interest score. Responsive to the user interest score being above the interest threshold, the media item reference may be identified, otherwise, the media item reference may not be identified.

At 406, a second content provider, that provides the media item referenced in the media item reference, may be identified. The second content provider may comprise a streaming provider that streams media, a media provider such as a cable or satellite provider, a media merchant that sells media, a brick and mortar media item dealer, and/or some other provider that provides the media item. Any number of content providers may be identified that provide the media item. For example, a third content provider (e.g., a streaming provider) that provides the media item may be identified.

The user may have an account with the second content provider, the third content provider, and/or other content providers. A client device of the user may have a device identifier. A request to link the client device using the device identifier to the second content provider may be received from the user. The device identifier may be linked with the second content provider so that the user may quickly access media items from the second content provider (e.g., the user may submit and/or save account login information for the account with the second content provider).

A first link to the second content provider, a second link to the third content provider, and/or other links to content providers may be created using a user management component. The user management component may, with user consent, generate a log comprising user account credentials for the second content provider, the third content provider, etc. In an example, a link may be created to a content provider with which the user does not have to provide credentials.

The first link may be utilized to identify the second content provider as providing one or more media items for consumption by the user. The second link may be utilized to identify the third content provider as providing one or more media items for consumption by the user.

Given user consent, the log may be generated by the user management component in order to remember user account credentials input into content providers. In an example, the log may be generated based upon the user inputting user account credentials into the user management component.

At 408, a media queuing option, corresponding to the second media provider, may be provided for the media item. A second media queuing option, corresponding to the third media provider, may be provided for the media item. The media queuing option and/or the second media queuing option may comprise a media item purchase option (e.g., an option to purchase the media item for digital access, mail order, store pickup, or download), a media item viewing option (e.g., an option to watch the media item), a media item reservation option (e.g., an option to reserve the media item for future viewing), a media item pickup option (e.g., an option to reserve a tangible copy of the media item for physical pick up), a media item bookmark option (e.g., an option to save a web address and/or website linking to the media item for future viewing), and/or a media item record option (e.g., an option to record the media option). The media queuing option and/or the second media queuing option may be the same or different options.

Media queuing options may be displayed on a search engine results page. The media queuing option may be displayed in a first location of the search engine results page based upon a first media queue bid submitted by the second content provider. The second media queuing option may be displayed in a second location of the search engine results page based upon a second media queue bid submitted by the third content provider. The first location may have a higher visibility prominence metric than the second location based upon the first media queue bid being larger than the second media queue bid.

At 410, responsive to receiving an invocation of the media queuing option, the media item may be queued for consumption through the second content provider (e.g., queued for immediate playback; queued for purchase; queued for pickup; etc.). Responsive to a second invocation of the second media queuing option, the media item may be queued for consumption through the third content provider. In this way, the user may queue the media item for consumption from various content providers.

The invocation may correspond to a single user interaction with the media queuing option. In an example of the single user interaction, where the second content provider comprises a streaming media provider and a media queuing option comprises a media item viewing option, the media item may be opened in a same or different webpage for consumption. In an example of the single user interaction, where the third content provider comprises a media provider and the second media queuing option comprises a media item record option, the media item may be scheduled to be recorded and a notification that the media item has been scheduled to be recorded may be presented to the user.

In an example, the invocation may comprise redirecting the user to a user interface, populated with contextually relevant information, associated with the media item. In an example, the invocation may comprise submitting user account credentials, of the user, to the second content provider and instructing the second content provider to queue the media item for consumption by the user (e.g., where a link to the second content provider has not yet been established).

In an example where the second content provider comprises a media merchant and the media queuing option comprises a media item purchase option, the user may be taken to a user interface comprising a confirmation (e.g., a notification asking the user to confirm the user's intent to purchase), an option to play the media item, and/or an option to download the media item. Responsive to the user selecting an option from the user interface, the media item may be queued for consumption in the manner prescribed by the option selected. At 412, the method 400 ends.

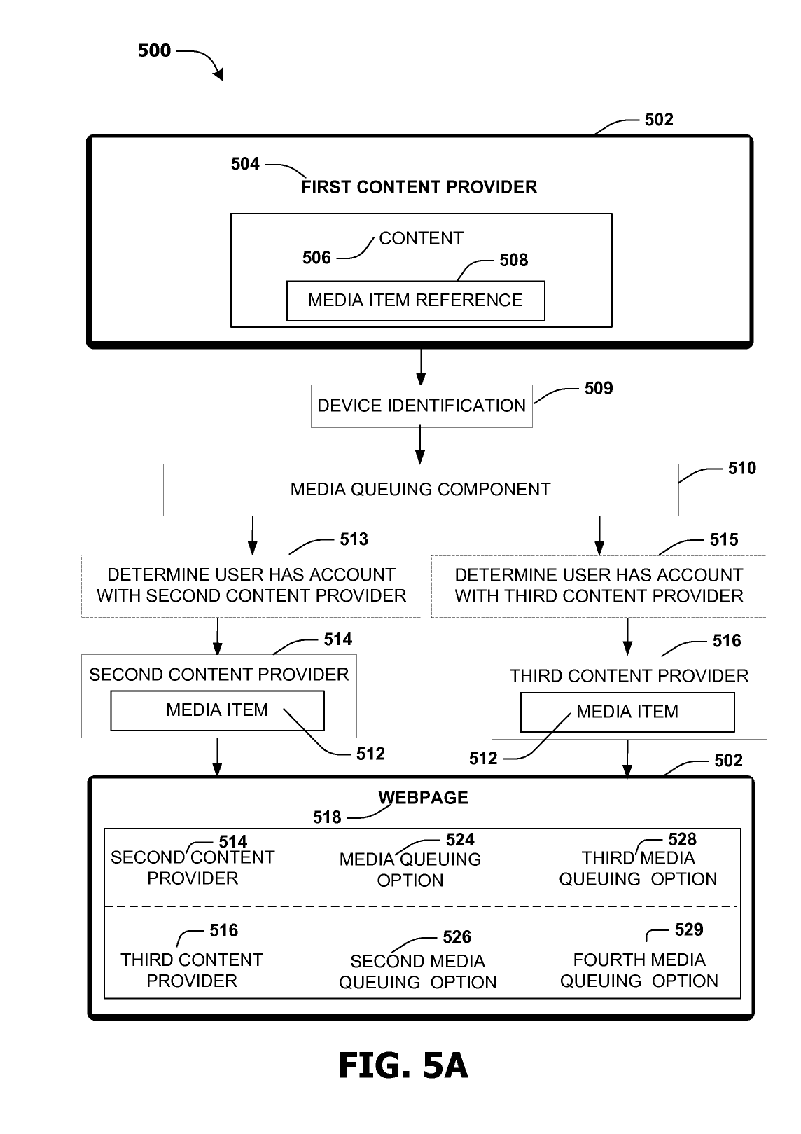

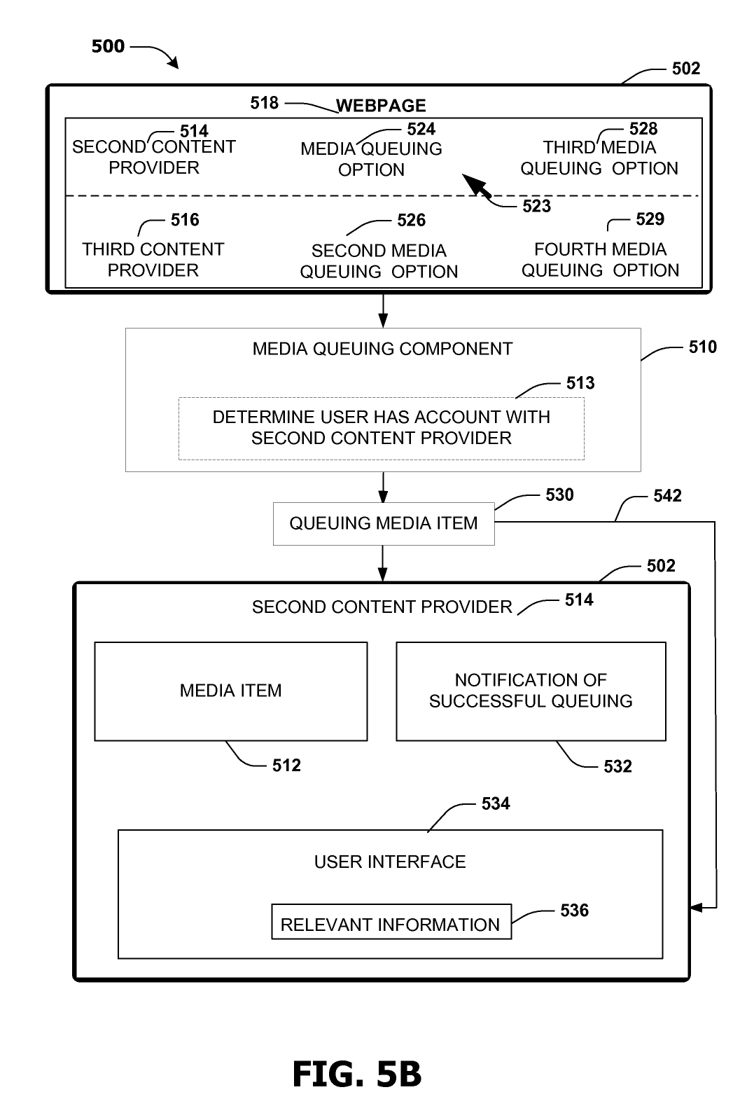

FIGS. 5A-5B illustrate a system 500, comprising a media queuing component 510, for providing a media item 512, referenced by a media item reference 508 within content 506 associated with a first content provider 504. The user, on a client device 502, may create the content 506 through the first content provider 504 (e.g., create a social network post on a social network hosted by the first content provider 504). The content 506 may comprise the media item reference 508. The media item reference 508 may be identified based upon a determination that the user has an interest in the media item 512, referenced by the media item reference 508, above an interest threshold (e.g., a user profile and/or user history may indicate that the user has a strong interest in the media item 512).

A device identification 509 of the client device 502 may be sent to the media queuing component 510. The media queuing component 510 may determine 513 that the user has an account with a second content provider 514 from which the media item 512 is available. The media queuing component 510 may determine 515 that the user has an account with a third content provider 516 from which the media item 512 is available. The media queuing component 510, given user consent, may utilize a user management component to maintain a log of user account credentials used to access such accounts. The media queuing component 510 may determine that the media item 512 is provided by the second content provider 514 and/or the third content provider 516.

Responsive to the media queuing component 510 determining that the second content provider 514 comprises the media item 512, a media queuing option 524 may be provided for the media item 512 on a webpage 518 or any other interface (e.g., through an email, a social network post, a message, an application interface, a mobile alert, an interface element of the first content provider 504, etc.). Responsive to the media queuing component 510 determining that the third content provider 516 comprises the media item 512, a second media queuing option 526 may be provided for the media item 512 on the webpage 518.

The webpage 518 may comprise an interface populated with a first entry corresponding to the media queuing option 524 (e.g., an option to purchase the media item 512) and a third media queue option 528 (e.g., an option to save the media item 512 for later) for the second content provider 514. The interface may be populated with a second entry corresponding to the second media queuing option 526 (e.g., an option to reserve a physical copy of the media item 512 for rental) and a fourth media queue option 529 (e.g., an option to purchase the physical copy of the media item 512) for the third content provider 516.

FIG. 5B illustrates the user invoking 523 the media queuing option 524 as provided by the second content provider 514. Responsive to the media queuing component 510 receiving the invocation 523 of the media queuing option 524, the media queuing component 510 may determine 513 that the user has the account with the second content provider 514. The media queuing component 510 may utilize the user management component to maintain the log of user account credentials, such as user account credentials for the second content provider 514.

Responsive to the media queuing component 510 receiving the invocation 523 of the media queuing option 524, the media item 512 may be queued 530 for consumption through the second content provider 514. The invocation 523 may correspond to a single user interaction with the media queuing option 524. In an example of the single user interaction, the queuing the media item 530 may comprise presenting, through the second content provider 514, the media item 512, or a notification of successful queuing 532. The presenting the media item 512 may comprise playing the media item 512. The presenting may occur in the webpage 518 or any other interface (e.g., an email notification, a social network post notification, a media viewer application to play the media item 512, etc.).

The invocation 523 may comprise redirecting 542 the user to a user interface 534, populated with contextually relevant information 536 associated with the media item 512, provided by the second content provider 514. The invocation 523 may comprise submitting user account credentials, of the user, to the second content provider 514 and instructing the second content provider 514 to queue the media item 530 for consumption by the user. The relevant information 536 may comprise a confirmation (e.g., a notification asking the user to confirm the user's intent to purchase, bookmark, reserve, and/or the like), an option to play the media item, and/or an option to download the media item.

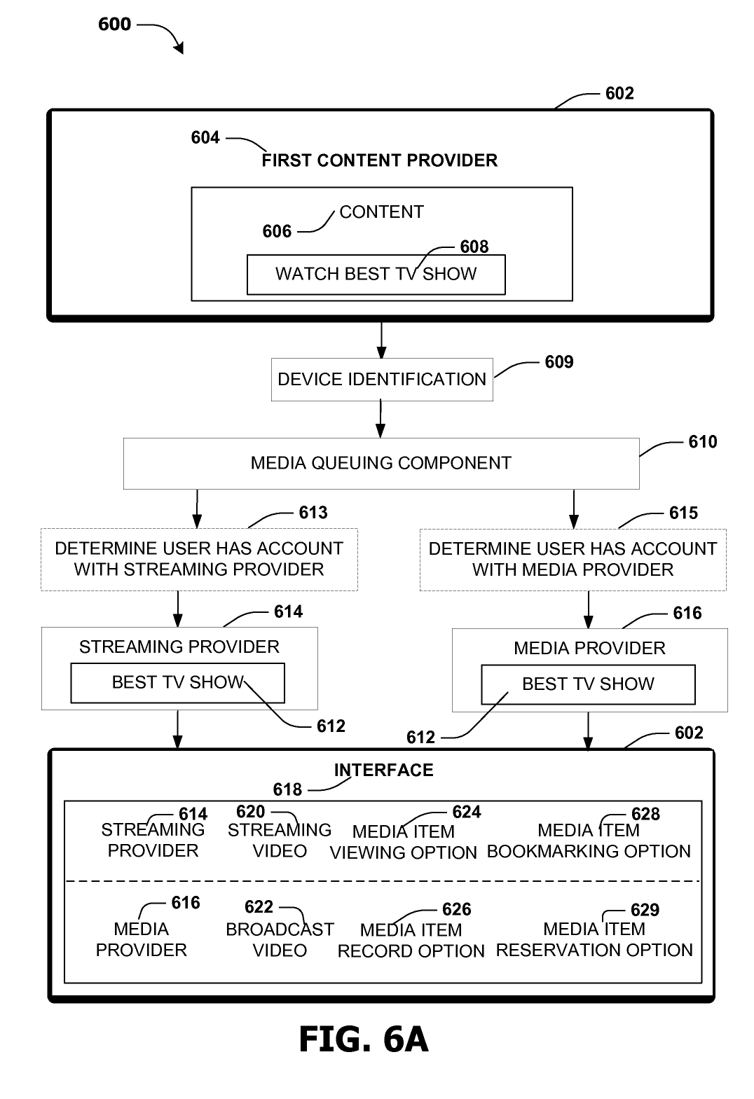

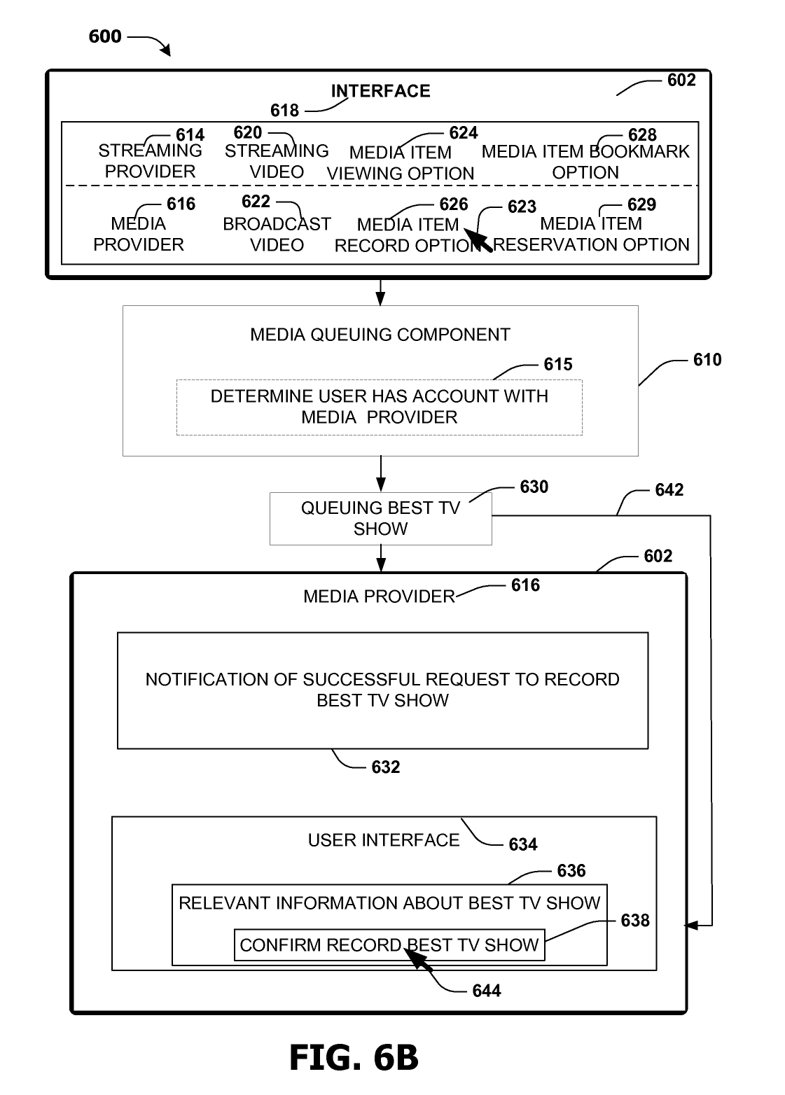

FIGS. 6A-6B illustrate a system 600, comprising a media queuing component 610 for providing a best TV show 612, referenced by a best TV show reference 608 within content 606 associated with a first content provider 604. The user, on a client device 602, may create the content 606 through the first content provider 604 (e.g., create a social network post on a social network hosted by the first content provider 604). The content 606 may comprise the best TV show reference 608. The first content provider 604 may comprise a search engine, a webmail service, a social network, etc. The best TV show reference 608 may be identified based upon a determination that the user has an interest in the best TV show 612, referenced by the best TV show reference 608, above an interest threshold (e.g., a user profile and/or user history may indicate that the user has a strong interest in the best TV show 612).

A device identification 609 of the client device 602 may be sent to the media queuing component 610. The media queuing component 610 may determine 613 that the user has an account with a streaming provider 614 from which the best TV show 612 is streamed. The media queuing component 610 may determine 615 that the user has an account with a media provider 616 from which the best TV show 612 may be obtained. The media queuing component 610, given user content, may utilize a user management component to maintain a log of user account credentials used to access such accounts.

The media queuing component 610 may determine that the best TV show 612 is provided by the streaming provider 614 and/or the media provider 616. One or more additional content providers (not shown) may be identified that provide the best TV show 612.

Responsive to the media queuing component 610 determining that the streaming provider 614 comprises the best TV show 612, a media item viewing option 624 (e.g., an option to stream the best TV show 612) and/or a media item bookmarking option 628 (e.g., saving a web address and/or a webpage for future viewing) may be provided for the best TV show 612 on an interface 618.

Responsive to the media queuing component 610 determining that the media provider 616 comprises the best TV show 612, a media item recording option 626 (e.g., an option to record the best TV show 612 when it next airs and/or anytime it airs) and/or a media item reservation option 629 (e.g., an option to reserve the best TV show 612 at a location that rents or sells the best TV show 612) may be provided for the best TV show 612 through the interface 618.

The interface 618 may be populated with a first entry corresponding to the streaming video 620 (e.g., a format in which the best TV show 612 is offered by the streaming provider 614), the media item viewing option 624, and/or the media item bookmarking option 628 associated with the streaming provider 614. The interface 618 may be populated with a second entry corresponding to a broadcast video 622 (e.g., a format in which the best TV show 612 is offered by the media provider 616), the media item record option 626, and/or the media item reservation option 629 associated with the media provider 616.

FIG. 6B illustrates the user invoking 623 the media item record option 626 provided by the media provider 616. Responsive to the media queuing component 610 receiving the invocation 623 of the media item record option 626, the media queuing component 610 may determine 615 that the user has an account with the media provider 616.

Responsive to the media queuing component 610 receiving the invocation 623 of the media item record option 626, the best TV show 612 may be queued 630 for consumption through the media provider 616. The invocation 623 may correspond to a single user interaction with the media item record option 626. In an example of the single user interaction, the queuing the best TV show 630 may comprise scheduling a recording of the best TV show 612 and presenting, through the media provider 616, a notification 632 of a successful request to record the best TV show 612.

The invocation 623 may comprise redirecting 642 the user to a user interface 634, populated with contextually relevant information 636 associated with the best TV show 612, provided by media provider 616. The invocation 623 may comprise submitting user account credentials, of the user, to the media provider 616 and instructing the media provider 616 to queue 630 the best TV show 612 for consumption by the user. The relevant information 636 may comprise a confirmation 638 (e.g., a notification asking the user to confirm the user's intent to record). Responsive to the user selecting 644 the confirmation 638, the best TV show 612 may be scheduled to be recorded, and the user may be presented with a notification of the successful request to record the best TV show 632.

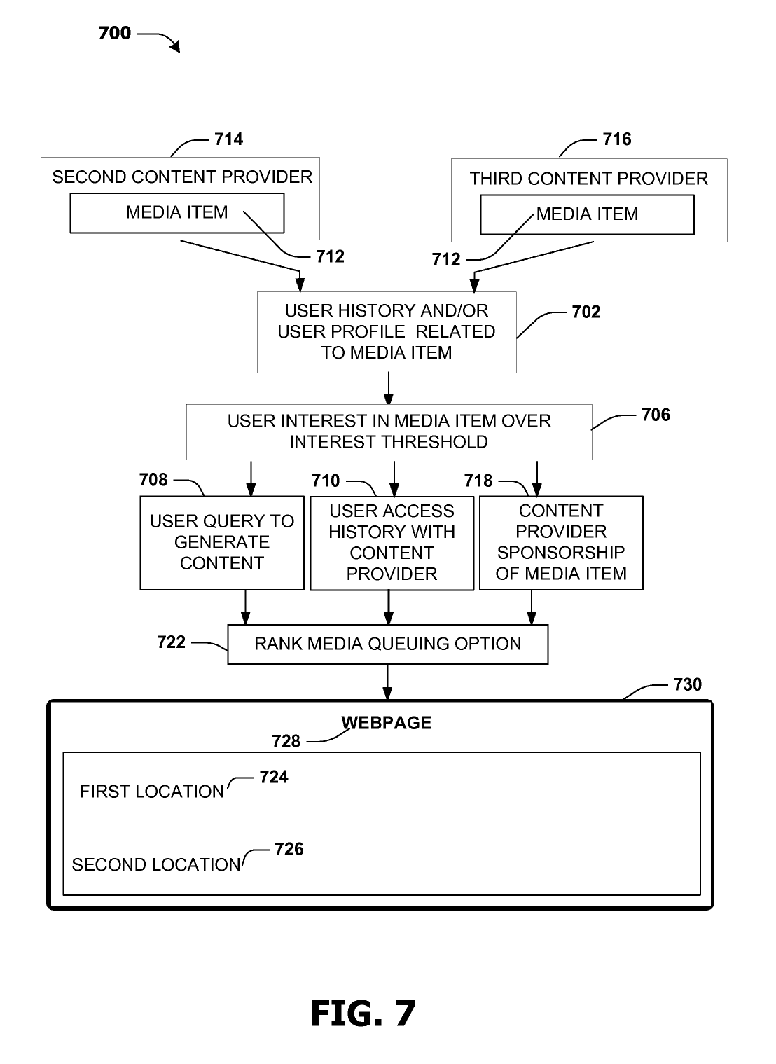

FIG. 7 illustrates a system 700 for ranking 722 media queuing options. Responsive to a user on a client device 730 referencing a media item 712 through content on a first content provider, a search may be performed to determine whether the media item 712 is available on a second content provider 714 and/or a third content provider 716. A user history associated with interactions with the first content provider, the second content provider 714, and/or the third content provider 716 may be evaluated to identify a user preference for media items. The user history may comprise a number of instances that the user viewed a certain type of media item (e.g., a genre, such as horror, action, fantasy, comedy, etc.), a number of times the user viewed media items with certain actors, actresses, and/or directors, association information (e.g., information about media item preferences and/or a number of times the user's social media connections, email recipients, etc. mentioned the media item, actors, actresses, directors, etc.), and/or behavioral information (e.g., information about the user's habits and/or custom with regard to the media item or similar media items). The user history may comprise one or more recommendations, generated by the second content provider 714 and/or the third content provider 716, on what the user may prefer, which may be based upon the user's past viewing history with the second content provider 714 and/or the third content provider 716 (e.g., the user history may indicate that the user prefers to watch the Big Bird sports team play the Big Dog sports team, rather than watch the Big Bird sports team play the Big Pirate sports team). In an example, a group of users that are similar to the user (e.g., a users cohort) above a similarity threshold may be identified. Preferences of the group of users may be used to determine the user's preference for media items. A user's user profile associated with the first content provider, the second content provider 714, and/or the third content provider 716 may be evaluated to identify a user preference for media items. The user profile may comprise information about the user's preference regarding the media item, a type of media item, actors, actresses and/or directors, demographic information (e.g., age, gender, etc. of the user) and/or geographic information (e.g., state, country, etc. in which the user resides).

Responsive to determining that the user history and/or user profile comprises content related 702 to the media item 712, a determination on whether the user interest in the media item 712 is over an interest threshold 706 may be performed. A user interest score may be determined by considering the user history, the user profile, and/or terms/phrases near the media item reference.

Responsive to the user interest score for the media item 712 being above the interest threshold 706, the second content provider 714 and/or the third content provider 716 may present one or more media queuing options. The one or more media queuing options may comprise a media item purchase option (e.g., an option to purchase the media item), a media item viewing option (e.g., an option to watch the media item), a media item reservation option (e.g., an option to reserve the media item for future viewing), a media item pickup option (e.g., an option to reserve the media item for pick up), a media item bookmark option (e.g., an option to save a web address and/or website linking to the media item for future viewing), and/or a media item record option (e.g., an option to record the media option).

The one or more media queuing options may be ranked 722 by determining a score based upon a user query 708 that generated the content, the user's access history 710 with a content provider (e.g. the first content provider, the second content provider 714, and/or the third content provider 716), convenience to the user (e.g., whether the content provider provides the media item on one or more client devices; whether the content provider adds cost to the user; whether the content provider has advertisements; whether, based upon the content provider having advertisements, the advertisements may be skipped; and/or whether the media provider has storage limitations), and/or whether the content provider sponsors 718 the media item 712. The score may be based upon a first media queue bid submitted by the second media provider 714 and/or a second media queue bid submitted by the third media provider 716. The first media queue bid and/or the second media queue bid may have a same or different basis for payment. In an example, the basis for the payment may comprise a payment for a listing on a webpage 728, a payment contingent on the media item 712 being viewed using the second content provider 714 and/or the third content provider 716, a fraction of a media rental fee for the media item 712, a fraction of a subscription fee paid by the user to the second content provider 714 and/or the third content provider 716, etc.). The media queuing options may be presented on the webpage 728. The highest ranked media queuing option may be presented in a first location 724, the second highest ranked media queuing option may be presented in a second location 726, etc. The first location 724 may have a higher visibility prominence than the second location 726.

In an example of scoring, if the user query 708 includes words that indicate that the user may want to watch the media item 712 presently, then a first score (e.g., a score of +5 or some other score) may be assigned to a media queuing option that provides immediate viewing options (e.g., the media viewing option), a second score (e.g., a score of +1 or some other score) may be assigned to a second media queuing option that provides viewing options in the near future (e.g., the media item record option), etc. In an example, the first media queuing option, having the highest score (e.g., 5), may be presented at the first location 724, and the second media queuing option, having the second highest score (e.g., 1), may be presented at the second location 726.

In an example, if the user predominantly uses the second content provider 714 and rarely uses the third content provider 716, then media queuing options that are provided by the second content provider 714 may be assigned a first preference score (e.g., a score of +2 or some other score) and media queuing options that are provided by the third content provider 716 may be assigned a second preference score (e.g., a score of +1 or some other score). A media queuing option provided by a fourth content provider, which the user has never used, may receive a third preference score (e.g., a score of 0 or some other score). In an example, the media queuing option presented by the second content provider 714, having the highest score (e.g., +2), may be presented at the first location 724, and the media queuing option presented by the third content provider 716, having the second highest score (e.g., +1), may be presented at a second location 726.

In an example, a convenience score may be assigned based upon storage limitations of content providers and storage utilization by a user. For example, a relatively lower convenience score (e.g., a +1 score) may be assigned to the second content provider 714 based upon the user having less than a threshold amount of media storage remaining with the second content provider 714 (e.g., the user may be close to reaching a media storage limit of the second content provider 714, such that the user may have to delete media items to create available media storage for new media items). A relatively higher convenience score (e.g., a +3 score) may be assigned to the third content provider 716 based upon the user having more than the threshold amount of media storage remaining with the third content provider 716. In an example, the media queuing option presented by the third content provider 716, having the highest score (e.g., +3), may be presented at the first location 724, and the media queuing option presented by the second content provider 714, having the second highest score (e.g., +1), may be presented at the second location 726. In an example, if the second content provider 714 adds cost to the user (e.g., the second content provider 714 requires a membership fee and the user is not already a member) then the second content provider 714 may receive a lower convenience score than the third content provider 716 that does not add cost to the user. In an example, if the second content provider 714 has advertisements and/or advertisements that may not be skipped (e.g., the user may implement a fast forward option during the advertisements), then the second content provider 714 may receive a lower convenience score than the third content provider 716 that does not have advertisements or allows users to skip advertisements.

In an example, if the second content provider 714 is sponsoring the media item 712, then media queuing options presented by the second content provider 714 may have a first sponsor score (e.g., a score of about +3 to about +10 or some other score, depending on a level of sponsorship), while media queuing options presented by the third content provider 716, which is not sponsoring the media item, may have a second sponsor score (e.g., a score of 0 or some other score). In an example, the media queuing option presented by the second content provider 714, having the highest score (e.g., +3 to about +10), may be presented at the first location 724, and the media queuing option presented by the third content provider 716, having the second highest score (e.g., 0) may be present at a second location 726. The one or more media queuing options may be ranked based on a cumulative score based upon a sum of all scores.

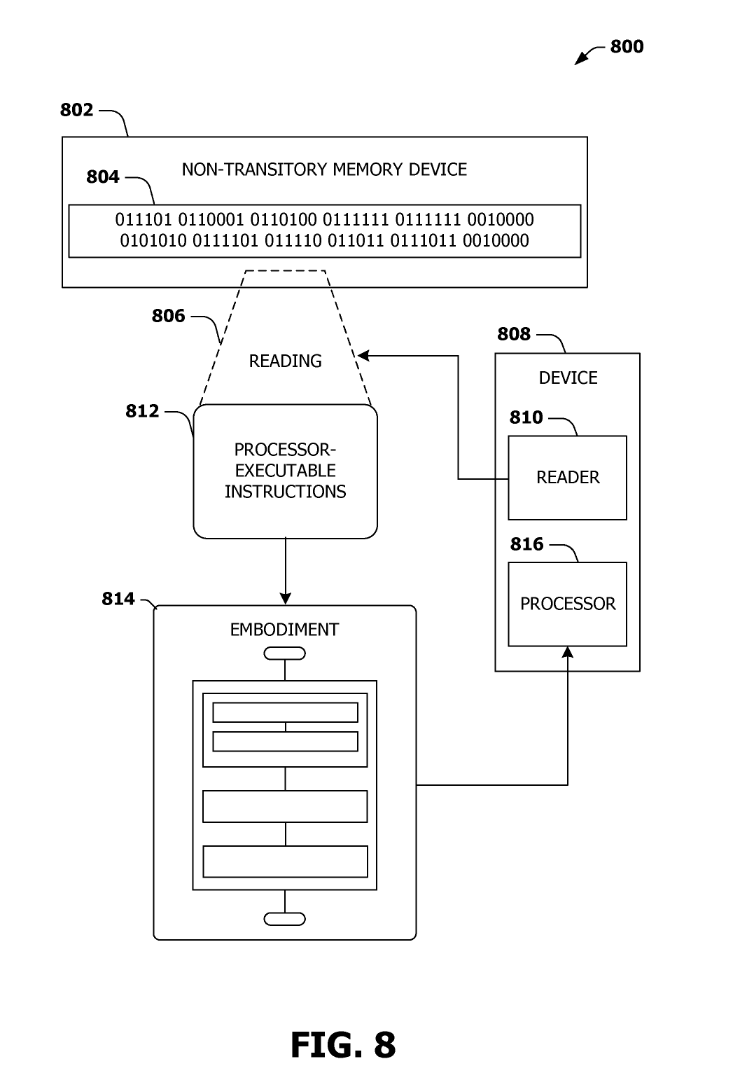

FIG. 8 is an illustration of a scenario 800 involving an example nontransitory memory device 802. The nontransitory memory device 802 may comprise instructions that when executed perform at least some of the provisions herein. The nontransitory memory device 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 802 stores computer-readable data 804 that, when subjected to reading 806 by a reader 810 of a device 808 (e.g., a read head of a hard disk drive, or a read operation invoked on a solid-state storage device), express processor-executable instructions 812. In some embodiments, the processor-executable instructions, when executed on a processor 816 of the device 808, are configured to perform a method, such as at least some of the example method 400 of FIG. 4, for example. In some embodiments, the processor-executable instructions, when executed on the processor 816 of the device 808, are configured to implement a system, such as at least some of the example system 500 of FIGS. 5A-5B, at least some of the example system 600 of FIG. 6A-6B, and/or at least some of the example system 700 of FIG. 7 for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of media queuing, comprising:
identifying a media item reference within content provided to a user by a first content provider;
identifying a second content provider that provides a media item referenced by the media item reference;
providing a media queuing option for the media item; and
responsive to receiving an invocation of the media queuing option, queuing the media item for consumption through the second content provider.

2. The method of claim 1, the media queuing option comprising at least one of a media item purchase option, a media item viewing option, a media item reservation option, a media item pickup option, a media item bookmark option, or a media item record option.

3. The method of claim 1, the identifying a second content provider comprising:
determining that the user has an account with the second content provider.

4. The method of claim 1, the content comprising at least one of a website, a search engine search page, a social network post, a message, or an application.

5. The method of claim 1, the invocation corresponding to a single user interaction with the media queuing option.

6. The method of claim 1, the queuing the media item comprising:
submitting user account credentials, of the user, to the second content provider; and
instructing the second content provider to queue the media item for consumption by the user.

7. The method of claim 1, the queuing the media item comprising:
redirecting the user to a user interface, populated with contextually relevant information associated with the media item, provided by the second content provider.

8. The method of claim 1, the identifying a media item reference comprising:
evaluating at least one of a user profile or a user history to determine that the user has an interest in the media item greater than an interest threshold.

9. The method of claim 1, the queuing the media item comprising:
providing the user with a notification that the media item was successfully queued with the second content provider.

10. The method of claim 1, comprising:
receiving an account link request requesting to link an account, of the user with the second content provider, with a user device of the user; and
linking a device identifier of the user device with the second content provider to create a link.

11. The method of claim 10, identifying a second content provider comprising:
responsive to determining that the content is provided to the user device of the user, utilizing the link to identify the second content provider as providing one or more media items for consumption by the user.

12. The method of claim 1, comprising:
identifying a third content provider that provides the media item;
providing a second media queuing option for the media item; and
responsive to receiving a second invocation of the second media queuing option, queuing the media item for consumption through the third content provider.

13. The method of claim 1, the first content provider comprising a search engine search page, and the providing a media queuing option comprising:
displaying the media queuing option in a first location of a search engine results page, generated from the search engine search paged, based upon a first media queue bid submitted by the second content provider; and
displaying the second media queuing option in a second location of the search engine results page based upon a second media queue bid submitted by a third content provider, the first location having a higher visibility prominence metric than the second location.

14. The method of claim 1, comprising:
generating a set of media queuing options associated with a plurality of content providers that provide the media item; and
ranking the set of media queuing options to create a ranked set of media queuing options based upon at least one of a user query used to generate the content, a user access history with a content provider, or a content provider sponsorship of the media item.

15. A system for media presentation, comprising:
a media queuing component configured to:
identify a media item reference within content provided to a user by a first content provider;
identify a second content provider that provides a media item referenced by the media item reference;
identify a third content provider that provides the media item referenced by the media item reference;
provide a media queuing option for the media item provided by the second content provider;
provide a second media queuing option for the media item provided by the third content provider;
responsive to receiving an invocation of the media queuing option, queue the media item for consumption through the second content provider; and
responsive to receiving an invocation of the second media queuing option, queue the media item for consumption through the third content provider.

16. The system of claim 15, the media queuing component configured to:
provide the media queuing option by providing at least one of a media item purchase option, a media item viewing option, a media item reservation option, a media item pickup option, a media item bookmark option, or a media item record option; and
provide the second media queuing option by providing at least one of the media item purchase option, the media item viewing option, the media item reservation option, the media item pickup option, the media item bookmark option, or the media item record option.

17. The system of claim 15, the invocation corresponding to a single user interaction with the media queuing option or the second media queuing option.

18. The system of claim 15, the media queuing component configured to:
identify the second content provider by determining that the user has an account with the second content provider; and
identify the third content provider by determining that the user has an account with the third content provider.

19. A non-transitory computer readable medium comprising computer executable instructions that when executed by a processor perform a method for media queuing, comprising:
identifying a media item reference within content provided to a user on a first content provider;
identifying a second content provider that provides a media item referenced by the media item reference;
identifying a third content provider that provides the media item referenced by the media item reference;
providing a first media queuing option for the media item;
providing a second media queuing option for the media item;
responsive to receiving an invocation of the first media queuing option, queuing the media item for consumption through the second content provider; and
responsive to receiving an invocation of the second media queuing option, queuing the media item for consumption through the second content provider.

20. The method of claim 19, the identifying a media item reference comprising:
evaluating at least one of a user profile or a user history to determine that the user has an interest in the media item greater than an interest threshold.
